(19) United States
(12) Patent Application Publication
(10) Pub. No.: US 2009/0001749 A1
(43) Pub. Date: Jan. 1, 2009

(54) VEHICLE SEAT UMBRELLA HOLDER

(76) Inventors: Steven M. Johnson, Shelby Twp., MI (US); Shawn R. Williams, Auburn Hills, MI (US); D. Scott Bittinger, Fenton, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/771,117

(22) Filed: Jun. 29, 2007

(51) Int. Cl. B60R 7/12

(52) U.S. Cl. 296/37.15

(57) ABSTRACT

An umbrella retaining device may be incorporated into or integrally attached to a vehicle seat from the vehicle factory and may employ a compartment or holder that defines a ventilation and drain hole to drain water from a wet umbrella. An umbrella compartment may further comprise a flap pivoting along a bottom edge of the compartment, a gusset on each side of the flap, and a snap or magnetic closure device proximate to the flap's upper edge. Alternatively, an umbrella retaining compartment may angularly lie within a bottom portion of the seat or seat supporting portion, such as a front seat side shield. The compartment may have a cover, such as a pivoting cover. Alternatively, the umbrella retaining member may be a vertical tubular restraining member with a top, angled opening and a bottom opening. A support loop may lie below the tubular member to provide vertical support.

### FIELD

The present invention relates to a vehicle seat that accommodates an umbrella.

### BACKGROUND

Motor vehicles may include various storage compartments for storing items in the interior compartment of the vehicle. These storage compartments, however, typically are for items such as foldable maps, gloves, flashlights, etc. that are typically dry items and whose storage may be accommodated in any of the variety of storage compartments. While these storage compartments have been satisfactory for their intended uses, they are not without their share of limitations. One such limitation is that such storage compartments are not suited to handling the length of an umbrella. Another limitation is that such storage compartments are not within a convenient reach of a seated vehicle driver from a driver's seat. Another limitation is that such storage compartments are not equipped to drain water.

What is needed then is a device that does not suffer from the above limitations. This in turn will provide a device that will accommodate and drain water from a wet umbrella, including a compact and non-compact umbrella. Additionally, such a device will be located so as to be accessible without opening a driver's door of the vehicle.

### SUMMARY

A dedicated umbrella retaining device for a vehicle may be incorporated into or be an integral part of a vehicle seat, such as a driver seat, and may employ a compartment or holder that further defines a ventilation and drain hole to drain water that falls from a wet umbrella during storage.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a vehicle depicting the location of umbrella storage compartments in accordance with the present teachings;

FIG. 2 is a perspective front view of a vehicle seat depicting locations of umbrella storage compartments in accordance with the present teachings;

FIG. 3 is a perspective rear view of a vehicle seat depicting a location of an umbrella storage compartment in accordance with the present teachings;

FIG. 4 is a front view of a vehicle seat depicting locations where an umbrella may be stowed; and

FIG. 5 is a left side view of a vehicle driver's seat depicting location where an umbrella may be stowed.

### DETAILED DESCRIPTION

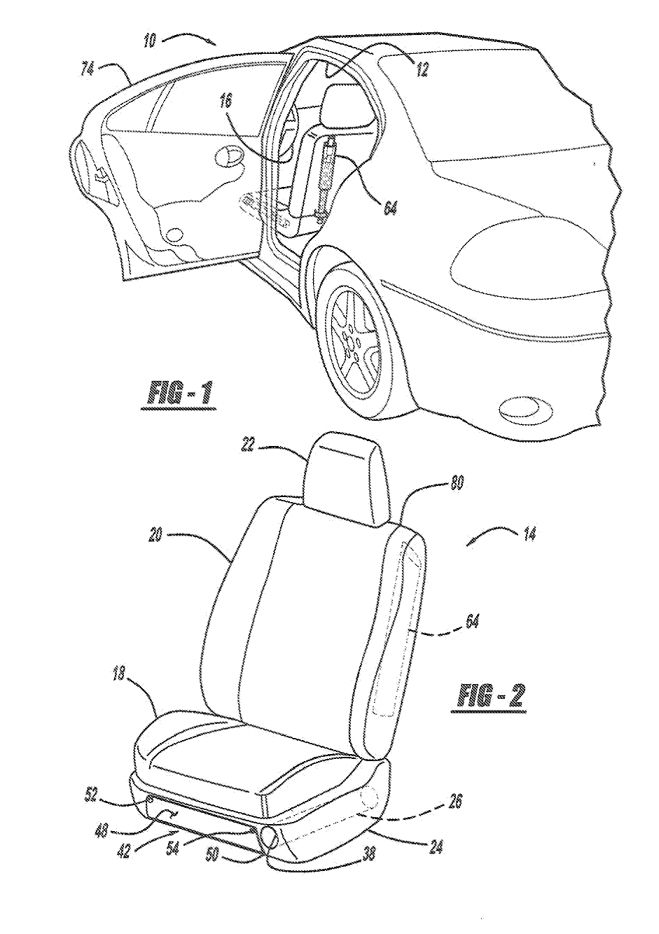

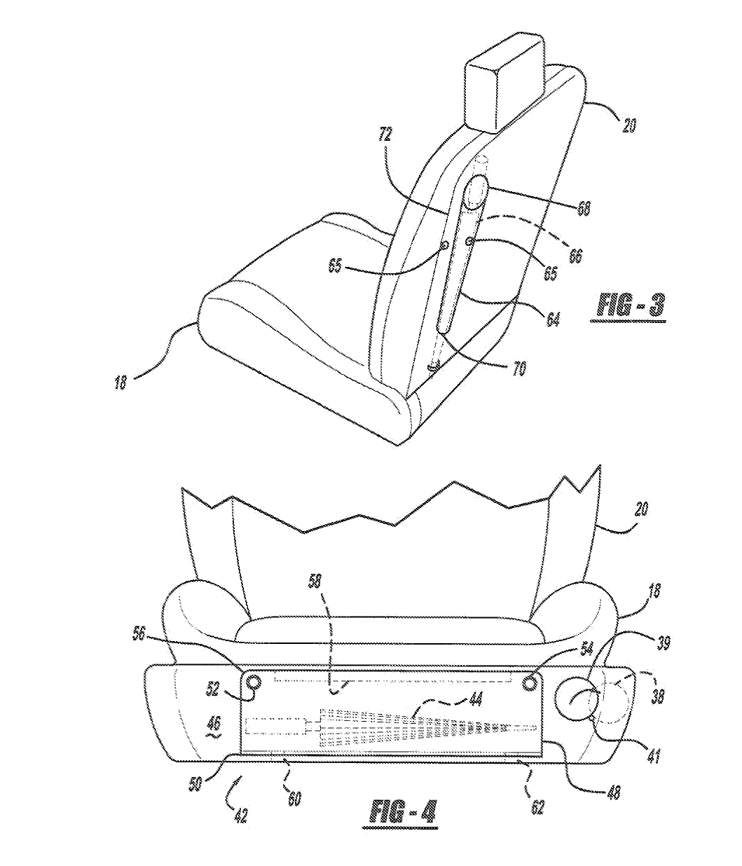

The following description is merely exemplary in nature and is in no way intended to limit the invention, its application, or uses. Turning to FIG. 1, a perspective view of a vehicle 10, such as an automobile, is depicted. Vehicle 10 has an interior compartment 12 within which vehicle seats are mounted, such as a driver seat 14. The driver seat 14 is situated behind a steering wheel 16 and beside or next to a driver's front door (not shown). With reference to FIG. 2, the drive seat 14 generally has a seat bottom 18 and a seat back 20, to which a head rest 22 is attached. Continuing with reference to FIGS. 1-5, the seat bottom 18 and seat back 20 may be configured to stow an umbrella. The seat bottom 18 may have a front seat side shield 24, which may he a hard plastic piece that assists in supporting and covering the seat structure of the seat bottom 18. Within the front side shield 24, a tubular cavity 26 may be molded to stow an umbrella 28 when not in use. With reference primarily to FIG. 5, the cavity 26 may span the entire depth of the seat bottom 18 of the driver seat 14 or only part of the depth. For instance, if the umbrella is a compact umbrella, then the cavity 26 may be terminated at an intermediate rear wall 30, which may be at some intermediate distance through the depth of the seat bottom 18, or at the rear wall 32 of the front seat side shield 24, which may be more nearly through the entire depth of the seat bottom side shield 24. In another possibility, the umbrella cavity 26 may be a cavity that passes entirely through the seat bottom 18 thereby defining a rear opening 40 at the rear of the front seat side shield 24.

Continuing with reference to FIG. 5, the cavity 26 may have a drain hole 34 when the umbrella cavity 26 terminates at an intermediate distance through the seat bottom 18. Such a drain hole 34 would drain water from an interior of the cavity 26 through the bottom of the front seat side shield 24. Water may be shed from or drain from an umbrella 28 if it is inserted into the cavity 26 when wet, such as immediately after being used. Alternatively, a drain hole 36 may be resident at the rear end of a cavity 26 when the cavity is present up to, but not passing out of a rear of the seat bottom 18. In such a configuration, the drain hole 36 would be present just below a rear wail 32 of the front seat side shield 24. In yet another configuration, in the event the cavity 26 passes entirely through the front seat side shield 24, a front opening 38 and rear opening 40 are defined. When the cavity 26 passes entirely through the seat bottom 18, no drain hole, per se, is necessary because water from a wet umbrella 28 may pass from the cavity 26 via the rear opening 40. As depicted, to drain wafer from the drain hole 34, drain hole 36 or rear opening 40, the cavity 26 is pitched or angled such that the rear of the cavity, which is at the rear of the driver seat 14, is lower than the front of the cavity 26. In addition to draining water, the holes 34, 36 and opening 40 facilitate airflow through the cavity 26 to hasten drying of the cavity 26 and any residing umbrella 28. A cover 39 may be provided over the front opening 38. Such may be a piece of matching material as the front surface 46. The cover 39 may pivot on a pivot pin or pivot point 41.

With continuing reference to FIGS. 2, 4 and 5, another location for umbrella storage with a driver seat 14 will be presented. Beginning with FIG. 2, a front compartment 42 is defined within which an umbrella 44 may be stored. The compartment 42 may be defined by the front surface 46 of the seat and a cover 48. As the cover 48 wraps over and around a stowed umbrella 44, a tubular compartment 42 is formed. The front surface 46 may be a hard plastic material that assists in supporting and covering the seat structure of the seat bottom 18. Alternatively, the front surface 46 may be a vinyl, leather or other material that is stretched or applied over a seat supporting structure. Continuing with FIGS. 2, 4 and 5, the front cover 48 may be hinged along a lower area or a lower edge 50 of the front cover 48, and in one example, the front cover 48 may be sewn directly to the material over the surface 46 or directly to the surface 46. Additionally, to secure a top edge 56 of the front cover 48 to the surface 46, a first fastener 52 and a second fastener 54 may be employed. First fastener 52 and second fastener 54 may be snaps, a latch or magnetically attractive fasteners, for example. Alternatively, instead or in addition to the fasteners 52, 54 a length of a hook and loop fastener 58 may be used along the top edge 56 of the cover 48 to secure the cover 48 to the surface 46.

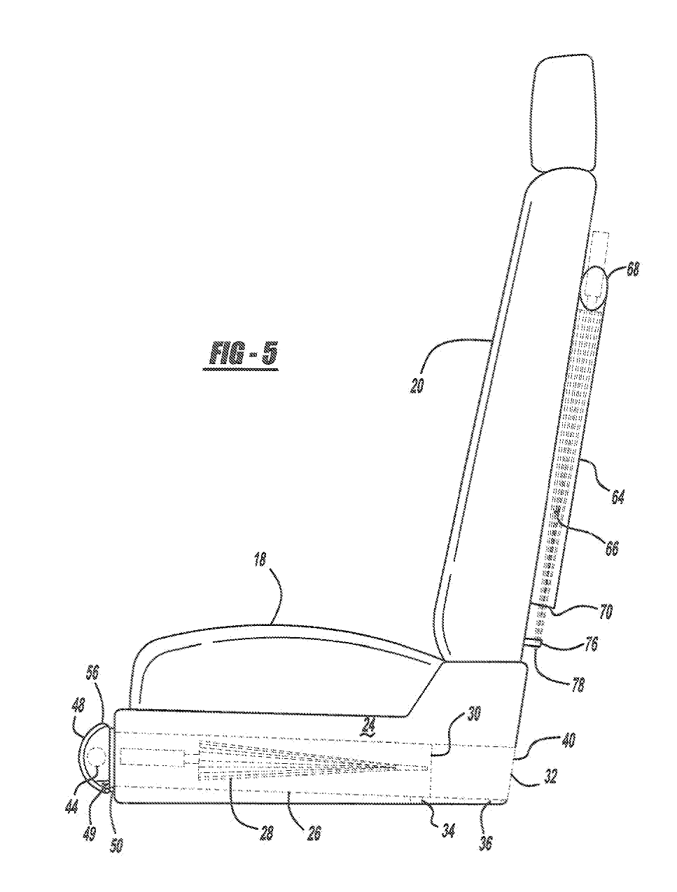

Continuing with FIGS. 4 and 5, the top edge 56 of material may be detached from the surface 46 to permit an umbrella 44 to be deposited into the compartment formed by the front cover 48 and surface 46. Because the front cover 48 may be made pliable, if for example the cover 48 were made from a piece of cloth or vinyl, the front compartment 42 may accommodate various sizes of compact, retractable umbrellas. Similar to the side compartment, one or more drain holes 60, 62 may be located at the bottom of the compartment 42, such as at the lower edge 50 of the compartment 42.

Turning now to FIGS. 1-3 and 5, another example of an umbrella holder that utilizes a vehicle seat, will be explained. Turning first to FIG. 1, a vertical seat back umbrella holder 64 within which an umbrella 66 may reside, is depicted. Turning now primarily to FIGS. 3 and 5, further description of the vertical seat back umbrella holder 64 will be presented. FIG. 3 depicts a vertical seat back umbrella holder 64 attached in the vicinity of a left (as shown) or right rear corner 72 of a driver seat 14. Continuing, the vertical seat back umbrella holder 64 has a top opening 68 and a bottom opening 70. More specifically, the top opening 68 may be slanted or angled, relative to a longitudinal axis of the umbrella holder 64, to facilitate withdrawal and insertion of the umbrella 66 with regard to the driver side of the vehicle, such as the driver side front door or driver side rear door 74 of the vehicle 10, depending upon the extent that the seat back 20 is reclined in the vehicle 10 or fore/aft position of the seat. For example, if the seat back 20 is in an upright position as depicted in FIG. 5, then the umbrella 66, may be drawn from the slanted or angled top opening 68 toward the exterior of the vehicle 10. To ensure that an umbrella is secure within the vertical seat back umbrella holder 64, a support loop 76 may be employed. More specifically, the support loop 76 may be a loop of material sufficient in strength to support the weight of an umbrella 66 as the umbrella 66 resides within the vertical seat back umbrella holder 64. Finally, a snap 65 may be located on the umbrella holder 64 and seat back 20 to secure the umbrella holder 64 more flatly against the seat back 20 and out of the way of the rear seat occupants when the umbrella holder 64 is not being used.

Continuing with reference to FIG. 5, the vertical seat back umbrella holder 64 may be a piece of material, such as nylon or a material with an elastic, expandable qualify to maintain the umbrella 66 in the vertical seat back umbrella holder 64. More specifically, when the umbrella 66 is inserted into the slanted top opening 68, the vertical seat back umbrella holder 64 may expand in a radial fashion to permit the umbrella 66 to be gripped or hugged in a fashion to maintain its position in the vertical seat back umbrella holder 64. The bottom support loop 76 may provide vertical support the umbrella 66 and permit the tip 78 of the umbrella from wandering in a radial fashion while the vehicle 10 is in motion. Likewise, the vertical seat back umbrella holder 64 prevents the umbrella 66 from moving in a radial and vertical fashion while if is installed within the vertical seat back umbrella holder 64. The vertical seat back umbrella holder 64 may be sewn directly to or info the seat back 20 or molded or otherwise incorporated with a seat back panel. Because the vertical seat back umbrella holder 64 is located on the rear of the seat back 20, it may accommodate a compact umbrella, a full size umbrella or even an oversized umbrella, such as a golf style of umbrella with an open arc, or distance from one tip to the opposite tip over the umbrella canopy, of greater than 54 inches, for example. Of course the vertical seat back umbrella holder 64 is designed to store a closed umbrella 66, as depicted. Because of its open bottom opening 70 and support loop 76 arrangement, the vertical seat back umbrella holder 64 facilitates air flow-through, that is, between the top opening 68 and bottom opening 70 through the holder 64. Such a design hastens drying of a wet umbrella.

The invention exhibits and affords multiple advantages. The umbrella compartments or holders 26, 42 and 64 may be located on nearly any seat in a vehicle, be they front seats or rear seats, on a driver side or a passenger side of a vehicle. Another advantage is that each of the umbrella compartments or holders 26, 42 and 64, when installed on a driver seat 14, can be accessed by a driver while seated in the seat 14, such that a driver door does not have to be opened to prepare an umbrella before stepping from a vehicle. Compartments 26 and 42 are especially convenient because they are positioned next to a driver while the vertical seat back umbrella holder 64 may be accessed by reaching over the shoulder area 80 of the seat 14, beside the headrest 22, or around a seat corner, such as the left rear corner 72.

Another advantage is that the slanted top opening 68 facilitates insertion and retraction of an umbrella 66 with respect to the vertical seat back umbrella holder 64. Still yet, anther advantage to the dedicated compartments and holders 26, 42 and 64 is that other vehicle compartments, such as glove boxes, will not become wet or dirty over time as may occur with the dedicated compartments and holders 26, 42 and 64. Further still, another advantage is that the umbrella compartments and holders 26, 42 and 64 are part of the seat itself, that is, such compartments and holders are not part of add-on attachments such as unattractive bolt-on options or as part of an aftermarket seat-covers. As such, the compartments and holders 26, 42 and 64 will not move, twist, become loose, or fall off as an aftermarket piece might do.

The description of the invention is merely exemplary in nature and, thus, variations that do not depart from the gist of the invention are intended to be within the scope of the invention. Such variations are not to be regarded as a departure from the spirit and scope of the invention.

1. An umbrella holder for a vehicle seat, the umbrella holder comprising:
a compartment, wherein the compartment defines a drain hole to drain water, the compartment further comprising:
a flap pivotally secured to the seat along a lower edge of the flap; and
a gusset on each side of the flap.

2-3. (canceled)

4. The umbrella holder of claim 1, wherein the compartment further comprises a closure device.

5. The umbrella holder of claim 1, wherein the compartment is located in front of a bottom seat cushion of the vehicle seat.

6. The umbrella holder of claim 1, wherein the compartment is located in a front side shield of the vehicle seat.

7. The umbrella holder of claim 1, wherein the compartment is angled downwardly from a front of the seat to a rear of the seat to hasten water drainage.

8. The umbrella holder of claim 6, wherein the compartment is located below a top surface of a bottom seat cushion of the vehicle seat.

9. The umbrella holder of claim 1, wherein the compartment is a hollow tube.

10. The umbrella holder of claim 1, wherein a longitudinal axis of the compartment is situated horizontally.

11. The umbrella holder of claim 1, wherein a longitudinal axis of the compartment is angled with respect to a horizontal axis.

12. An umbrella holder for a vehicle seat, the umbrella holder comprising:
a pliable tubular member defining a sleeve having a first opening adapted to receive an end of a folded umbrella, and a second opening smaller than the first opening.

13. The umbrella holder of claim 12, wherein a longitudinal axis of the tubular member Is situated vertically such that the first opening of the tubular member is positioned above the second opening of the tubular member.

14. The umbrella holder of claim 13, wherein the first opening is at a top end of the tubular member and the second opening is at a bottom end of the tubular member.

15. The umbrella holder of claim 14, further comprising: a support loop, the loop being situated below the second opening of the tubular member to provide support for the end of the folded umbrella projecting from the second opening.

16. The umbrella holder of claim 15 wherein the tubular member is adapted for attachment to a rear of a seat back.

17. The umbrella holder of claim 16 wherein the tubular member is adapted for attachment to an outboard corner of a rear of the seat back; and further comprising a snap, wherein the snap secures pad of the tubular member to the seat back.

18. The umbrella holder of claim 17, wherein the top end of the tubular member Is angularly shaped relative to a longitudinal axis of the tubular member to ease insertion and retraction of an umbrella.

19. (canceled)

20. An umbrella holder for a vehicle seat, the umbrella holder comprising:
a pliable member attached to a vehicle seat, wherein the pliable member defines a flexible pocket adapted to receive a folded umbrella.

21. The umbrella holder of claim 20, wherein the pliable member has a lower edge and a pair of side edges, and the lower edge of the pliable member is pivotally attached to the seat; and further including a gusset connecting each side edge of the pliable member to the seat.

22. The umbrella holder of claim 20, wherein the pocket is a tubular and includes a first opening adapted to receive an end of a folded umbrella, and a second opening smaller than the first opening.
